(19) United States
(12) Patent Application Publication
(10) Pub. No.: US 2019/0358563 A1
(43) Pub. Date: Nov. 28, 2019

(54) FILTER DEVICE

(71) Applicant: Lehmann & Voss & Co. KG, Hamburg (DE)

(72) Inventors: Simeon Niederer, Frauenfeld (CH); Frank Valentin Roeske, Berlin (DE)

(73) Assignee: Lehmann & Voss & Co. KG, Hamburg (DE)

(21) Appl. No.: 16/348,124

(22) PCT Filed: Oct. 30, 2017
(86) PCT No.: PCT/EP2017/077775

§ 371 Date: Aug. 14, 2019

(30) Foreign Application Priority Data
Nov. 2, 2016 (DE) 10 2016 120 877.9

(51) Int. Cl. B01D 24/00; B01D 39/06

(52) U.S. Cl. CPC B01D 24/008; B01J 20/28; B01D 39/06

(57) ABSTRACT

The invention relates to a filter device comprising an inlet and an outlet. An adsorption section is positioned along the flow path between and inlet section and an outlet section, and is filled with glass beads of a predetermined nominal diameter as well as an absorption granulate mixed with said glass beads. The inlet section and outlet section are filled with glass beads with a nominal diameter preferably at least as big as the nominal diameter of the glass beads of said adsorption section.

The invention relates to a filter device as can be used, for example, for reducing undesired compounds in liquids (for example, phosphates in ponds, natural baths, fountains, and circulating springs), but also, for example, in conjunction with electroplating baths.

DE 103 27 199 A1 describes how phosphorus compounds can be removed from water by bringing them into contact with an anionic polymer.

A multilayer filter having a filter medium and microbeads made of glass arranged upstream thereof as a filter aid is disclosed in U.S. Pat. No. 5,366,632.

Furthermore, filter cartridges are known in which water to be purified flows in succession through an inlet section filled with glass beads, an adsorption section filled with granulated grains of different sizes, which adsorb pollutants, and an outlet section filled with glass beads.

Such filter devices tend toward a relatively high flow resistance, which reduces the filter performance and can result in higher costs.

It is the object of the invention to provide an improved filter device having good flow rate behavior.

This object is achieved by a filter device having the features of claim 1. Advantageous designs of the invention result from the dependent claims.

The filter device according to the invention has an inlet, an outlet, and a flow path between the inlet and the outlet. The flow path, viewed in the flow direction, has a first section (inlet section), a second section (adsorption section), and a third section (outlet section), i.e., the medium entering through the inlet firstly flows through the first section, then the second section, and thereafter the third section and exits from the filter device through the outlet. The first section contains glass beads, the second section contains a mixture comprising glass beads and an adsorption granulate, and the third section contains glass beads.

When a medium charged with pollutants (for example, water containing undesired phosphates) flows through the filter device and past the granulated grains, pollutants can be adsorbed by the granulated grains. The term “adsorption” is to be understood very generally here; it also includes chemisorption. Adsorption granulates suitable depending on the intended use, for example, for adsorbing phosphates, are known and can be sought out for the use of the filter device planned in the specific case.

The word “filter device” is to be understood generally and is not to imply that solids have to be filtered out using the filter device according to the invention. The effect of the filter device is primarily based on the adsorption of undesired materials on or in the adsorption granulate. If needed, however, suitable solid filters can be connected upstream. In principle, the mechanical filter action implicitly provided by the filling of the filter device could also be used, which could result in a reduction of the service life of the filter device, however.

The first section of the filter device according to the invention preferably exclusively contains glass beads.

The second section preferably exclusively contains a mixture of glass beads and an adsorption granulate. The third section preferably exclusively contains glass beads. In spite of the use of the term “exclusively”, however, unavoidable impurities can also occur in addition or, for example, abraded material from the granulated grains from the second section could enter the first or third section.

In preferred embodiments of the invention, the first section and the third section are filled with glass beads, the nominal diameter of which is at least as large as that of the nominal diameter of the largest glass beads in the second section. The glass beads in the second section preferably all have the same nominal diameter.

The term nominal diameter is used for the diameter of the glass beads here, because glass beads can vary somewhat in size because of production. A typical tolerance range for the diameter at given nominal diameter is, for example, a deviation of ±5% or ±10% from the nominal diameter. Glass beads can also be marketed with specification of a predetermined diameter range, which extends, for example, over 1 mm width. In this case, the nominal diameter can be a suitable numeric specification (not necessarily the mean value of the diameter range), which characterizes this diameter range. If glass beads are marketed according to fractions, glass beads having the same nominal diameter can be in the same fraction.

The second section preferably adjoins the first section, and the third section adjoins the second section. In this case, the first section can adjoin the inlet and the outlet can adjoin the third section. This means that the sections follow one another directly. Intermediate boundaries, for example, intermediate walls or inserts designed like screens between the individual sections can be omitted, but are not fundamentally precluded.

The granulated grains of the adsorption granulate are quasi-fixed by the glass beads in the second section. Many flow channels can be formed between these particles, the cross section of which is also dependent on the proportion of granulated grains of smaller size. If the grain size varies over a predetermined range and a noteworthy proportion of granulated grains is significantly smaller than the glass beads, the flow resistance of the second section is greater than if fewer of such small granulated grains are present or if the grain size of the granulated grains even corresponds to the nominal diameter of the glass beads. On the other hand, the adsorption capability of the second section increases with the specific surface area of the granulated grains, i.e., with growing proportion of smaller granulated grains. The dwell time of the medium to be filtered in the filter device can also increase with the flow resistance, whereby the filtering becomes more thorough. A person skilled in the art will be able to perform an adaptation of the grain size of the adsorption granulate in consideration of these aspects for a given application. Glass beads are generally inert and relatively cost-effective.

Larger glass beads in the first and in the third section form larger flow channels and enable a good flow distribution toward the second section, so that the cross-sectional area thereof may be utilized as completely as possible, and away from the second section, in particular if the fittings for the inlet and the outlet of the filter device have a significantly smaller cross-sectional area than the filter device. These glass beads are either not sufficiently large that a noteworthy proportion of particles from the second section could penetrate into the intermediate spaces between the glass beads in the first and in the third section, or the filling of the filter device is at least stabilized as a whole, without partitions (for example, partition screens) being required between the individual sections.

The first section can have at least two subsections filled with glass beads, the nominal diameter of which is equal in the respective subsection. In this case, the nominal diameter of the glass beads of the individual subsections increases in the direction toward the inlet. Accordingly, the third section can also have at least two subsections filled with glass beads, the nominal diameter of which in the respective subsection is equal, and wherein the nominal diameter of the glass beads of the individual subsections increases in the direction toward the outlet. A multilayered structure of the first or third section enables a better adaptation of the inflow or outflow, respectively, to achieve a uniform flow through the second section in the case of relatively low flow resistance. In this case, the use of relatively large glass beads in the vicinity of the inlet or outlet is also permitted, which could be problematic directly adjacent to the second section because of the possibility of mixing of the glass beads in the case of very strongly differing sizes.

There are numerous options for the grain size distribution in the adsorption granulate and the nominal diameter of the glass beads.

Thus, for example, the grain size of the adsorption granulate can correspond to the nominal diameter of the glass beads in the second section. Since the granulated grains are generally not spherical, but rather formed irregularly, in such an embodiment, granulated grains have to be selected, the size of which matches with that of the glass beads. This can be carried out, for example by a screening method (see below).

In other embodiments, the grain size of the adsorption granulate is delimited at the upper end by the (largest) nominal diameter of the glass beads in the second section. In this case, smaller granulated grains are thus also used. The grain size of the adsorption granulate can also not be delimited at the upper end by the nominal diameter of the glass beads in the second section, however. A lower limit in the size of the granulated grains is preferably provided, which the predominant number of the granulated grains (for example, 98 wt.-% or 99 wt.-%) does not fall below.

If the size of the granulated grains does not fall below a predetermined lower limit, this delimits the specific surface area of the granulated grains, and intermediate spaces exist within the second section. This has effects on the adsorption behavior (in particular if the adsorption takes place on the surface of the granulated grains) and the flow resistance, as already explained above. The smallest grain size of the adsorption granulate is preferably in the range of 0.05 mm or 0.1 mm to 2.0 mm, wherein any intermediate value can also be selected. A suitable size distribution of the granulated grains can be determined by experiments, which does not have to be explained in greater detail for a person skilled in the art.

The nominal diameter of the glass beads in the second section is preferably in the range of 0.1 mm to 8 mm; while the nominal diameter of the glass beads in the first and in the third section is preferably in the range of 0.2 mm to 20 mm.

These are large ranges. The selection is performed in the individual case by a person skilled in the art according to criteria such as a desired flow rate or the adsorption behavior. Larger glass beads form larger intermediate spaces and can thus enable a lower flow resistance of the filter device, which means a higher flow rate.

The grain size of the adsorption granulate (or the size distribution) can be established by screening. If the granulated grains are not to be larger than the glass beads in the second section, this can be carried out as follows, for example: Firstly, a screen size is selected at which the given glass beads for the second section just fit through the meshes. This screen size is then used to preselect the adsorption granulate. If the grain size is to correspond to the diameter of the glass beads, the granulated grains which have fallen through are subsequently screened using a smaller screen size, preferably the next smaller in a standardized screen series, and all granulated grains which do not fall through now are taken for the adsorption section. Otherwise, a part of the granulated grains which fall through is also used, or screen sizes which differ more strongly are used from the outset, also for the case that granulated grains can be larger than the nominal diameter of the glass beads in the second section. The screening (screen analysis) can take place, for example, according to or similarly to DIN 66165.

In advantageous embodiments of the invention, the first section, the second section, and the third section are filled in a compacted manner, wherein the fillings thereof are kept in the compacted state by delimitation means at the inlet and at the outlet. “Compacted” in this context means that cavities, which may be noticeably reduced by vibrations, are no longer present between the particles in the individual sections. This can be achieved, for example, by shaking the housing during the filling of the filter device. A geometrically densest packing of the particles is not required, since a stabilization to avoid undesired mixing of the particles of adjacent sections is already achieved beforehand. The delimitation means also do not necessarily have to exert a pressure during operation of the filter device. The delimitation means do prevent a formation of (new) cavities, however, which could result in a destabilization.

A union nut having a screen insert, which is provided at the inlet and/or at the outlet of the filter device can be used as the delimitation means, for example. The screen can optionally even exert a pressure as the union nut is tightened, wherein the filling is somewhat compacted, this pressure also being able to dissipate again upon reaching a stable compacted configuration, however. The screen surface is preferably transverse to the longitudinal axis of the union nut. The screen pores are sufficiently small that they do not let through glass beads and can therefore certainly be relatively large so as not to cause a noticeable flow resistance.

The length of the second section is preferably greater than the total of the lengths of the first section and the third section, wherein the lengths are measured in the direction of the flow path.

In advantageous embodiments of the invention, the filter device has a housing, on which the inlet and the outlet are attached. The housing can thus be designed like a cartridge having two opposing end faces, wherein the inlet is arranged on one end face and the outlet is arranged on the other end face. The inlet and the outlet preferably have a smaller cross section than the housing and are provided, for example, with fitting threads. It is also conceivable that the inlet and/or the outlet are arranged transversely to the longitudinal axis of the housing. If the housing is designed like a cartridge, the second section (adsorption section) can be located in the central region of the housing, the first section (inlet section) can be located in a region of the housing between the inlet and the adsorption section, and the third section (outlet section) can be located in a region of the housing between the second section and the outlet.

For example, the adsorption section can extend over ⅔, the inlet section over ⅙, and the outlet section over ⅙ of the length of the housing. ⅙ of the housing length is generally sufficient for good inflow or outflow of liquid into or out of, respectively, such a filter cartridge, and unnecessary housing length is not given away.

There are manifold options for the adsorption granulate. The adsorption granulate can thus be configured for adsorbing, for example, phosphates and/or arsenic. Suitable adsorption granulates for greatly varying applications are known from the prior art and can be selected as needed by a person skilled in the art.

The invention is described in greater detail hereafter on the basis of exemplary embodiments. In the figures of the drawings

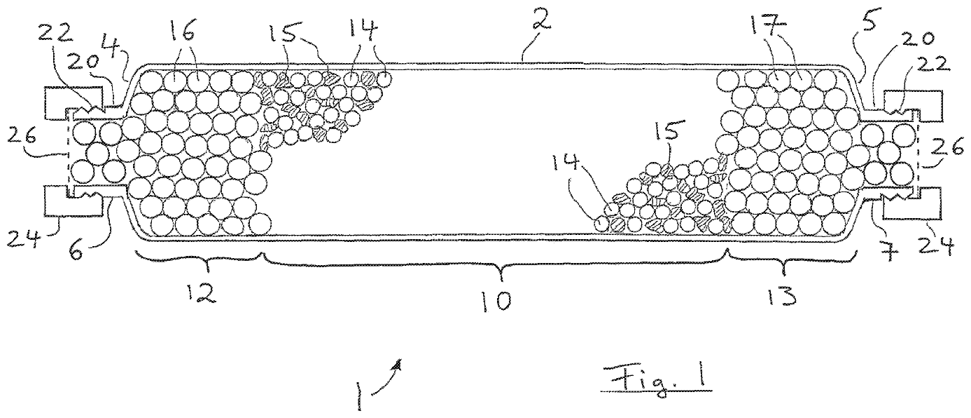

FIG. 1 shows a schematic longitudinal section through a first embodiment of the filter device according to the invention and

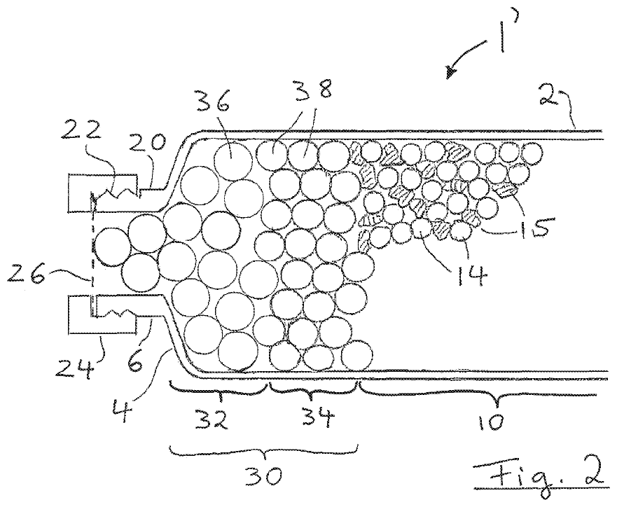

FIG. 2 shows a schematic longitudinal section through a second embodiment of the filter device according to the invention in partial section.

A first embodiment of a filter device is designed as a filter cartridge 1 and is shown in a schematic longitudinal section in FIG. 1.

The filter cartridge 1 has a housing 2 comprising an end face 4 and an opposing end face 5. An inlet 6 is located on the end face 4 and an outlet 7 is located on the end face 5.

The housing 2 is divided in the longitudinal direction into multiple zones, which are not separated from one another by any type of partition walls or screens, however. In the exemplary embodiment, these are three zones, specifically an adsorption section 10 in the central region of the housing 2, an inlet section 12 between the inlet 6 and the adsorption section 10, and an outlet section 13 between the adsorption section 10 and the outlet 7.

The adsorption section 10 is filled with glass beads 14 and an adsorption granulate 15, which is only shown in portions in the figures. The glass beads 14 all have a predetermined, equal nominal diameter.

Suitable glass beads, the diameter of which varies, for example, by ±5% or by ±10% in relation to the nominal diameter, are commercially available. In the exemplary embodiment, the glass beads 14 have a nominal diameter of 3 mm.

The grain size of the adsorption granulate 15 is set in the exemplary embodiment by screening to a range of 0.5 mm to 4 mm. The largest granulated grains are thus somewhat larger than the glass beads 14. For the sake of comprehensibility, only granulated grains which are approximately as large as the glass beads 14 are shown in FIG. 1.

In the adsorption section 10, the glass beads 14 and the adsorption granulate 15 are mixed through substantially uniformly. Since the size of the granulated grains is delimited at the lower end, no very small particles are present, which could clog the intermediate spaces between the glass beads 14 and the granulated grains. The flow resistance of the adsorption section 10 is therefore relatively low. The glass beads 14 and the adsorption granulate 15 essentially mutually fix one another, wherein the surfaces of the granulated grains are reached well by a liquid flowing through the adsorption section 10, which enhances the effectiveness of the filter cartridge 1.

The adsorption granulate 15 is configured for adsorbing specific materials (for example, phosphates or arsenic), which are thus removed from the medium flowing through the filter cartridge 1. Numerous substances can be used as the adsorption granulate, also mixtures of various substances. In this case, materials to be removed can be absorbed on the outer surface or also in pores in the volume of the granulated grains. In addition to physisorption, the granulated grains can also act exclusively or additionally via chemisorption. The numerous options for the selection of the adsorption granulate 15 are not the subject matter of this application.

Glass beads 16, the nominal diameter of which in the exemplary embodiment is greater than that of the glass beads 14 and is 5 mm, are located in the inlet section 12. The outlet section 13 similarly contains glass beads 17, the nominal diameter of which in the exemplary embodiment is also greater than that of the nominal diameter of the glass beads 14 and is equal to that of the glass beads 16. The intermediate spaces between the glass beads 16 and between the glass beads 17 are sufficiently small that the glass beads 14 cannot enter the inlet section 12 or the outlet section 13. Because of the extensive immobilization of the granulated grains of the adsorption granulate 15 by the glass beads 14, furthermore, only insignificant quantities of adsorption granulate pass into the inlet section 12 and the outlet section 13. On the other hand, the intermediate spaces between the glass beads 16 and 17 are sufficiently large because of the size of the glass beads 16, 17 that the flow resistance of the inlet section 12 or the outlet section 13, respectively, is relatively low.

The inlet 6 has a connecting piece 20 having an outer thread 22 (for example, a typical 1″, ¾″, or ½″ thread). A union nut 24, into which a screen seal 26 is introduced, is screwed onto the outer thread 22. An equivalent arrangement is located on the outlet 7, because of which the same reference signs are used for this purpose. The meshes or holes of the screen seals 26 can be relatively large, but do not permit passage of the glass beads 16 and/or 17. Other designs for the inlet 6 and the outlet 7 are also conceivable, for example, having additional threads for the incorporation into an existing installation.

The adsorption section 10, the inlet section 12, and the outlet section 13 are filled in a compacted manner. This means that the individual glass beads 14, 16, and 17 and the granulated grains of the adsorption granulate 15 only have minor movement options, so that no noticeable mixing takes place between the content of the inlet section 12 and/or the outlet section 13 and that of the adsorption section 10. This may be achieved, for example, by shaking during the filling. To achieve a compaction sufficient for practice, however, dense sphere packing is not required, which would not be possible in any case in the adsorption section 10 because of the irregular shape of the granulated grains. A sufficiently dense state can be stabilized with the aid of the union nuts 24. As the union nuts 24 are tightened, some pressure can even be exerted if the glass beads 16 and 17 initially protrude somewhat into the inlet 6 or the outlet 7, respectively, after the filling.

If a medium (for example, water, from which pollutants are to be removed) flows through the filter cartridge 1, the medium enters via the inlet 6 into the inlet section 12, where it can flow through many channels between the glass beads 16 and is thus distributed substantially uniformly over the cross section of the housing 2. The medium then permeates through the adsorption section 10, where the granulated grains of the adsorption granulate 15 can absorb pollutants from the medium. The medium then flows through the glass beads 17 of the outlet section 13, from which it is conducted in a manner favorable for flow to the outlet 7.

FIG. 2 shows a partial section of a schematic longitudinal section through a second embodiment of the filter cartridge, which is identified here by 1′. Otherwise, the same reference signs are used for parts corresponding to one another in FIG. 2 as in FIG. 1.

In the embodiment according to FIG. 2, the inlet section identified by 30 has two subsections, specifically a first subsection 32 and a second subsection 34 comprising glass beads 36 and 38, respectively. The nominal diameter of the glass beads 38 in the exemplary embodiment is larger than that of the glass beads 14 and smaller than that of the glass beads 36. The differences in nominal diameter are not sufficiently large that the glass beads of adjacent subsections or sections could mix with one another, however. In the exemplary embodiment according to FIG. 2, the glass beads in the adsorption section have a nominal diameter of 3 mm, the glass beads 38 have a nominal diameter of 5 mm, and the glass beads 36 have a nominal diameter of 10 mm. The outlet section (not shown in FIG. 2) of the filter cartridge 1′ is constructed similarly to the inlet section 30, i.e., also having two layers comprising glass beads of 5 mm or 10 mm nominal diameter, respectively, wherein the latter are arranged in the layer close to the outlet.

In the embodiment according to FIG. 2, the adsorption section 10 contains an adsorption granulate having a grain size of 0.5 mm to 4 mm (not shown accurately in FIG. 2).

In a further exemplary embodiment, the inlet section and the outlet section each have three subsections, respectively having glass beads of 10 mm, 5 mm, and 3 mm diameter, wherein the adsorption section contains glass beads of 3 mm diameter comprising an adsorption granulate of a grain size in the range of 0.5 mm to 4 mm.

A multilayered structure of the inlet section and/or the outlet section can ensure an improvement of the flow behavior in the filter cartridge, i.e., in particular a reduction of the overall flow resistance of the filter cartridge, and the most uniform possible distribution of the liquid to be filtered over the cross section of the adsorption section.

The filter cartridge may be used, for example, for reducing undesired compounds, for example, phosphates, in ponds, natural baths, fountains, and circulating springs. In standing or closed bodies of water, the filter cartridge can be used in a circuit, wherein water is continuously pumped in circulation. In this case, the water can flow completely through the filter cartridge, however, a bypass can also be used. Furthermore, multiple filter cartridges can be connected in series or also in parallel. There are many usage options.

1. A filter device comprising:
an inlet,
an outlet, and
a flow path between the inlet and the outlet, wherein the flow path, viewed in the flow direction, includes a first section, a second section, and a third section,
aid first section contains glass beads,
said second section contains a mixture comprising glass beads and an adsorption granulate,
aid third section contains glass beads.

2. The filter device as claimed in claim 1, wherein the first section and the third section are filled with glass beads, the nominal diameter of which is at least as large as that of the nominal diameter of the largest glass beads in the second section.

3. The filter device as claimed in claim 2, wherein the first section has at least two subsections filled with glass beads, wherein the nominal diameter of the glass beads in a respective subsection is equal and wherein the nominal diameter of the glass beads of the individual subsections increases in the direction toward the inlet.

4. The filter device as claimed in claim 2, wherein the third section has at least two subsections filled with glass beads, wherein the nominal diameter of the glass beads in a respective subsection is equal and wherein the nominal diameter of the glass beads of the individual subsections increases in the direction toward the outlet.

5. The filter device as claimed in claim 2, wherein the glass beads in the second section have equal nominal diameter.

6. The filter device as claimed in claim 1, wherein the second section adjoins the first section and the third section adjoins the second section.

7. The filter device as claimed in claim 1, further comprising at least one of the following features: the grain size of the adsorption granulate corresponds to the nominal diameter of the glass beads in the second section; the grain size of the adsorption granulate is delimited at the upper end by the largest nominal diameter of the glass beads in the second section; the grain size of the adsorption granulate is not delimited at the upper end by the nominal diameter of the glass beads in the second section; the smallest grain size of the adsorption granulate is in the range of 0.1 mm to 2.0 mm; the grain size of the adsorption granulate is delimited at the lower end by 0.05 mm, 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, or 2.0 mm; the nominal diameter of the glass beads in the second section is in the range of 0.1 mm to 8 mm; the nominal diameter of the glass beads in the first and in the third section is in the range of 0.2 mm to 20 mm.

8. The filter device as claimed in claim 1, wherein the grain size of the adsorption granulate is established by screening.

9. The filter device as claimed in claim 1, wherein the first section, the second section, and the third section are filled in a compacted manner, wherein the fillings thereof are kept in the compacted state by delimiters at the inlet and at the outlet.

10. The filter device as claimed in claim 9, wherein a union nut having a screen insert is provided at the inlet and/or at the outlet as the delimiter.

11. The filter device as claimed in claim 1, wherein the length of the second section is greater than the total of the lengths of the first section and the third section, wherein the lengths are measured in the direction of the flow path.

12. The filter device as claimed in claim 1, further comprising a housing, on which the inlet and the outlet are attached.

13. The filter device as claimed in claim 12, wherein the housing comprises a cartridge having two opposing end faces, wherein the inlet is arranged on one end face and the outlet is arranged on the other end face.

14. The filter device as claimed in claim 13, wherein the second section extends over ⅔, the first section over ⅙, and the third section over ⅙ of the length of the housing.

15. The filter device as claimed in claim 1, wherein the adsorption granulate is configured to adsorb at least one of the following substances: phosphate, arsenic.

16. The filter device as claimed in claim 3, wherein the third section has at least two subsections filled with glass beads, wherein the nominal diameter of the glass beads in a respective subsection is equal and wherein the nominal diameter of the glass beads of the individual subsections increases in the direction toward the outlet.

17. The filter device as claimed in claim 16, wherein the glass beads in the second section have equal nominal diameter.

18. The filter device as claimed in claim 16, wherein the first section, the second section, and the third section are filled in a compacted manner, wherein the fillings thereof are kept in the compacted state by delimiters at the inlet and at the outlet.

19. The filter device as claimed in claim 16, wherein the length of the second section is greater than the total of the lengths of the first section and the third section, wherein the lengths are measured in the direction of the flow path.

20. The filter device as claimed in claim 16, wherein the adsorption granulate is configured to adsorb at least one of the following substances: phosphate, arsenic.
